(19) United States
(12) Patent Application Publication
(10) Pub. No.: US 2004/0117859 A1
(43) Pub. Date: Jun. 17, 2004

(54) Multiple channel data recorder and method for recording data on multiple channels

(76) Inventor: Hagai Ohel, Coconut Creek, FL (US)

Correspondence Address: LERNER AND GREENBERG, P.A., POST OFFICE BOX 2480, HOLLYWOOD, FL, 33022-2480, US

(21) Appl. No.: 10/320,948

(22) Filed: Dec. 16, 2002

(51) Int. Cl. H04N 7/16; H04N 5/91; H04N 7/173; H04N 7/20; H04N 7/08

(52) U.S. Cl. 725/146; 725/90; 725/62; 725/63; 725/118; 725/116

(57) ABSTRACT

A multiple channel data recorder and a method for recording data on multiple wireless communications channels includes a transceiver, a display, and a processor programmed to selectively record the user's transmission for playback by at least one of the user and another user and, if another new transmission starts to be received by the user during the user's transmission, to continue transmitting the user's transmission and to record the new transmission at least from a beginning of the new transmission for playback, or to stop transmitting the user's transmission and to start recording at least a remainder of the user's transmission at least from the beginning of the new transmission for playback, and to receive the new transmission by the user.

### BACKGROUND OF THE INVENTION

1. Field of the Invention

The invention lies in the field of electronic recording of data. The invention relates to a multiple channel data recorder and method for recording data on multiple channels.

2. Description of the Related Art

Presently, multi-party communication, in particular, voice communication, typically occurs over a single communications channel. With such communication, a first party can talk to a second party and, while the first party remains talking, all other parties on that communication channel are muted until the first party finishes the message. This kind of communication is typical for walkie-talkie units, for example.

Alternatively, there can be a superior party that has the ability to talk over any first party currently talking on a multi-party channel. A common example of such communication exists with public safety communications such as police and fire/rescue. In an example where police are communicating with one another, when a first officer is talking over the dispatch channel, all other officers tuned into that channel can hear the first officer and cannot talk until the first officer completes the communication. However, if a police dispatcher begins talking, the first officer's transmission is cut off and the dispatcher's communication is transmitted over the dispatch channel instead of the first officer's transmission. This feature is referred to herein as overtalk. In some instances of overtalk, the first officer would not know that the dispatcher was talking until that officer's transmit button was released, which, then, would enable the audio reception speaker on that officer's unit and play the remaining portion of dispatcher's communication, if any. During such communication, the first officer's message, cut off by the dispatcher's interruption, is entirely lost. In other words, no part of the cut off message remains for anyone to listen to, whether concurrently or at a later time. It is also possible to lose communications data when the first officer's zeal for continuing communication in spite of the dispatcher's overtalk prevented the first officer from entirely hearing the dispatcher's message. Presently, multi-party communication systems are not able to capture any of these “lost” communications.

These kinds of multi-party communications exist with both mobile and portable communication devices. As set forth herein, a “mobile” communication device is one that is mounted in a moving object, such as a car or other vehicle, such as an ambulance, or even in a robot. In contrast, as set forth herein, a “portable” communication device is one that a single person can easily carry, such as a cell phone or walkie-talkie.

Various communications networks exist throughout the world, and these networks are standardized, but are not all compatible. For example, in the United States, public safety entities communicate through radio using the Association of Public Safety Communications Officials standard, also referred to as the APCO standard. Public safety entities of the European Union, for example, in comparison, communicate using the Terrestrial Trunked Radio standard, also referred to as the TETRA standard.

With respect to cellular communications, in the United States, principally the Code Division Multiple Access (CDMA), the Advanced Mobile Phone System (AMPS), and the Global System for Mobile Communication (GSM) standards are used. In comparison, the GSM standard is primarily used in the European Union and elsewhere.

### SUMMARY OF THE INVENTION

Accordingly, the invention provides a multiple channel data recorder and method for recording data on multiple channels that overcome the hereinafore-mentioned disadvantages of the heretofore-known devices and methods of this general type and that prevent loss of communications during overtalk.

With the foregoing and other objects in view, there is provided, in accordance with the invention, a method for recording data on multiple wireless communications channels, including the steps of selectively recording the user's transmission for playback by at least one of the user and another user, and, if another new wireless transmission starts to be received by the user during the user's transmission, then performing one of continuing transmission of the user's transmission and recording the new wireless transmission at least from a beginning of the new wireless transmission for playback by at least one of the user and another user, and stopping transmission of the user's transmission and at least starting to record at least a remainder of the user's transmission at least from the beginning of the new wireless transmission for playback by at least one of the user and another user, and receiving the new wireless transmission by the user.

In accordance with another mode of the invention, the selective recording is carried out by determining, upon initiation of a user's wireless transmission, if another wireless transmission is being received already by the user and, if so, recording the user's transmission for playback by at least one of the user and another user, and, if not, beginning transmission of the user's transmission.

In accordance with a further mode of the invention, there is a determination, upon initiation of a user's wireless transmission on a given communications link, if another wireless transmission is being received already by the user on the same or a different communications link. The communications link can be a link including a communications channel and/or a communications network.

In accordance with an added mode of the invention, the continuing transmission step is carried out by continuing transmission of the user's transmission and simultaneously recording the new wireless transmission at least from a beginning of the new wireless transmission for playback by at least one of the user and another user.

In accordance with an additional mode of the invention, the stopping, starting, and receiving steps are carried out by immediately stopping transmission of the user's transmission and immediately starting to record at least a remainder of the user's transmission at least from the beginning of the new wireless transmission for playback by at least one of the user and another user, and simultaneously immediately receiving the new wireless transmission by the user.

In accordance with yet another mode of the invention, at least one of the recording steps is carried out by digitally storing the recorded transmission in a memory. The recorded transmission can be stored in any format, including, but not limited to, mp3, wav, wma, real audio, quicktime, avi, mpeg, bmp, jpeg, gif, divx, and raw digital data, for example. The digital recording can be carried out by writing the digitally recorded transmission on an external writing media, which can include, for example, a hardware memory device or an external storage media. The recording can be carried out by storing the recorded transmission in a memory located at a place of origin of the transmission, at a place of reception of the transmission, or both.

In accordance with yet a further mode of the invention, the user's transmission and/or the new wireless transmission can be digital data, including, but not limited to code, an audio signal, an image, and a video stream.

In accordance with yet an added mode of the invention, at least one of the recorded transmissions is played back after the new wireless transmission and/or after the user's transmission has ended. Playback can begin from a starting point of a recorded transmission and/or from a user-selected point of time within a recorded transmission.

In accordance with yet an additional mode of the invention, a processor can be used to carry out the step of recording the user's transmission and can be used to for later transmission and/or playback by the user and/or another user.

In accordance with again another mode of the invention, a processor can be used to carry out the steps of stopping of the user's transmission and starting the recording of at least the remainder of the user's transmission at least from the beginning of the new wireless transmission for later transmission and/or playback the user and/or another user.

In accordance with again a further mode of the invention, at least one of the recording steps can be carried out by substantially eliminating dead air within the recorded transmissions.

In accordance with again an added mode of the invention, at least one of the recording steps can be carried out by compressing at least one of the recorded transmissions and dead air within the recorded transmissions.

With the objects of the invention in view, there is also provided a method for recording data on multiple wireless communications channels, including the steps of determining, upon initiation of a user's wireless transmission, if another wireless transmission is being received already by the user and, if so, recording the user's transmission for playback by at least one of the user and another user, and, if not, beginning transmission of the user's transmission and, if another new wireless transmission starts to be received by the user during the user's transmission, performing one of the steps of continuing transmission of the user's transmission and recording the new wireless transmission at least from a beginning of the new wireless transmission for playback by at least one of the user and another user and stopping transmission of the user's transmission and starting to record at least a remainder of the user's transmission at least from the beginning of the new wireless transmission for playback by at least one of the user and another user, and receiving the new wireless transmission by the user.

With the objects of the invention in view, there is also provided a method for recording data including at least one of a digital code, a digital audio signal, a digital image, and a digital video stream on multiple wireless communications channels, including the steps of determining, upon initiation of a user's wireless transmission, if another wireless transmission is being received already by the user and, if so, digitally recording the user's transmission in at least one memory for playback by at least one of the user and another user and, if not, beginning transmission of the user's transmission, and if another new wireless transmission starts to be received by the user during the user's transmission, performing one of the steps of continuing transmission of the user's transmission and simultaneously digitally recording the new wireless transmission at least from a beginning of the new wireless transmission in the at least one memory for playback by at least one of the user and another user and immediately stopping transmission of the user's transmission and immediately starting to digitally record at least a remainder of the user's transmission at least from the beginning of the new wireless transmission in the at least one memory for playback by at least one of the user and another user, and simultaneously immediately receiving the new wireless transmission by the user; and playing back at least one of the recorded transmissions after at least one of the new wireless transmission has ended and the user's transmission has ended.

With the objects of the invention in view, there is also provided a multiple channel data recorder, including at least one wireless communications transceiver, a display, and a processor connected to the at least one transceiver and to the display, the processor being programmed to selectively record the user's transmission for playback by at least one of the user and another user, and, if another new wireless transmission starts to be received by the user during the user's transmission, the processor being programmed to one of continue transmitting the user's transmission and record the new wireless transmission at least from a beginning of the new wireless transmission for playback by at least one of the user and another user and stop transmitting the user's transmission and start recording at least a remainder of the user's transmission at least from the beginning of the new wireless transmission for playback by at least one of the user and another user, and receive the new wireless transmission by the user.

In accordance with another feature of the invention, the processor is programmed to carry out the selective recording by determining, upon initiation of a user's wireless transmission, if another wireless transmission is being received already by the user and, if so, to record the user's transmission for playback by at least one of the user and another user and, if not, to begin transmitting the user's transmission through the at least one transceiver.

In accordance with a further feature of the invention, the processor is programmed to carry out the recording of a transmission with the processor for later transmission and/or playback by the user and/or another user.

In accordance with an added feature of the invention, the processor is programmed to carry out the stopping of the user's transmission and the starting of the recording at least a remainder of the user's transmission with the processor at least from the beginning of the new wireless transmission for at least one of later transmission and playback by at least one of the user and another user.

In accordance with an additional feature of the invention, the at least one transceiver is a plurality of transceivers. These transceivers can include, for example, any of a simplex transceiver, a CDMA transceiver, a TDMA transceiver, an AMPS transceiver, a GSM transceiver, an APCO transceiver, and a TETRA transceiver, or any combination thereof. The transceivers can have a single common antenna, a plurality of antennae, or separate antennae, or any combination thereof.

In accordance with yet another feature of the invention, there is provided a bus connecting the at least one transceiver to the processor.

In accordance with yet a further feature of the invention, there is provided at least one memory connected to the processor for storing recorded transmission data. The processor can be programmed to play back recorded transmission data stored in the memory.

In accordance with yet an added feature of the invention, there is provided a writing device connected to the processor for writing data on an external writing media, the processor being programmed to write recorded transmission data stored in the memory on the external writing media.

In accordance with yet an additional feature of the invention, there is provided at least one speaker and at least one microphone each respectively connected to the processor.

In accordance with again another feature of the invention, the display has user-configurable display sections. The display can have user-configurable display sections. At least one of the display sections can be associated with each of the transceivers. Further, the display can be a touch-screen.

With the objects of the invention in view, there is also provided a multiple channel data recorder, including at least one wireless communications transceiver, a display, and a processor connected to the at least one transceiver and to the display, the processor being programmed to determine, upon initiation of a user's wireless transmission, if another wireless transmission is being received already by the user and, if so, to record the user's transmission for playback by at least one of the user and another user and, if not, to begin transmitting the user's transmission through the at least one transceiver, and, if another new wireless transmission starts to be received by the user during the user's transmission, the processor being programmed to one continue transmitting the user's transmission and record the new wireless transmission at least from a beginning of the new wireless transmission for playback by at least one of the user and another user and stop transmitting the user's transmission and start recording at least a remainder of the user's transmission at least from the beginning of the new wireless transmission for playback by at least one of the user and another user, and receive the new wireless transmission by the user.

With the objects of the invention in view, there is also provided a multiple channel data recorder, including a plurality of wireless communications transceivers including at least one of a simplex transceiver, a CDMA transceiver, a TDMA transceiver, an AMPS transceiver, a GSM transceiver, an APCO transceiver, and a TETRA transceiver, a display having user-configurable display sections, a speaker, a microphone, a processor connected to the transceivers, to the display, to the speaker, and to the microphone, at least one memory connected to the processor for storing recorded communications data, the processor being programmed to determine, upon initiation of a user's wireless transmission, if another wireless transmission is being received already by the user and, if so, to record the user's transmission at least in the memory for playback by at least one of the user and another user and, if not, to begin transmitting the user's transmission through the at least one transceiver, and if another new wireless transmission starts to be received by the user during the user's transmission, the processor being programmed to continue transmitting the user's transmission and to record the new wireless transmission at least in the memory at least from a beginning of the new wireless transmission for playback by at least one of the user and another user and to stop transmitting the user's transmission and to start recording at least a remainder of the user's transmission at least in the memory at least from the beginning of the new wireless transmission for playback by at least one of the user and another user, and to receive the new wireless transmission by the user, and to play back recorded communications data stored in the memory on at least one of the display sections, the speaker, and the microphone.

With the objects of the invention in view, there is also provided a multiple channel data recording system, including at least two multiple channel data recorders each having at least one wireless communications transceiver, a display, and a processor connected to the at least one transceiver and to the display, the processor being programmed to selectively record the user's transmission for playback by at least one of the user and another user and, if another new wireless transmission starts to be received by the first user from the second user during the first user's transmission, the processor being programmed to continue transmitting the first user's transmission and to record the second user's transmission at least from a beginning of the second user's transmission for playback by at least one of the first user and the second user and to stop transmitting the first user's transmission and to start recording at least a remainder of the first user's transmission at least from the beginning of the second user's transmission for playback by at least one of the first user and the second user, and to receive the second user's transmission by the first user.

Other features that are considered as characteristic for the invention are set forth in the appended claims.

Although the invention is illustrated and described herein as embodied in a multiple channel data recorder and method for recording data on multiple channels, it is, nevertheless, not intended to be limited to the details shown because various modifications and structural changes may be made therein without departing from the spirit of the invention and within the scope and range of equivalents of the claims.

The construction and method of operation of the invention, together with additional objects and advantages thereof, will be best understood from the description of the preferred embodiments when read in connection with the accompanying drawings.

### BRIEF DESCRIPTION OF THE DRAWINGS

FIG. 1 is a flow chart illustrating an exemplary embodiment of the method according to the invention; and

FIG. 2 is block circuit diagram of an exemplary embodiment of a communications unit according to the invention.

### DESCRIPTION OF THE PREFERRED EMBODIMENTS

With the present invention, a user has the ability to preserve all electronically communicated data, including, but not limited to, voice, code, pictures, and video, that previously would have been lost when a first transmitting entity was talked over by a second transmitting entity or when a second transmitting entity tried to communicate while a first entity was already transmitting. The invention also permits the user to play back any conversation, including the user's current conversation.

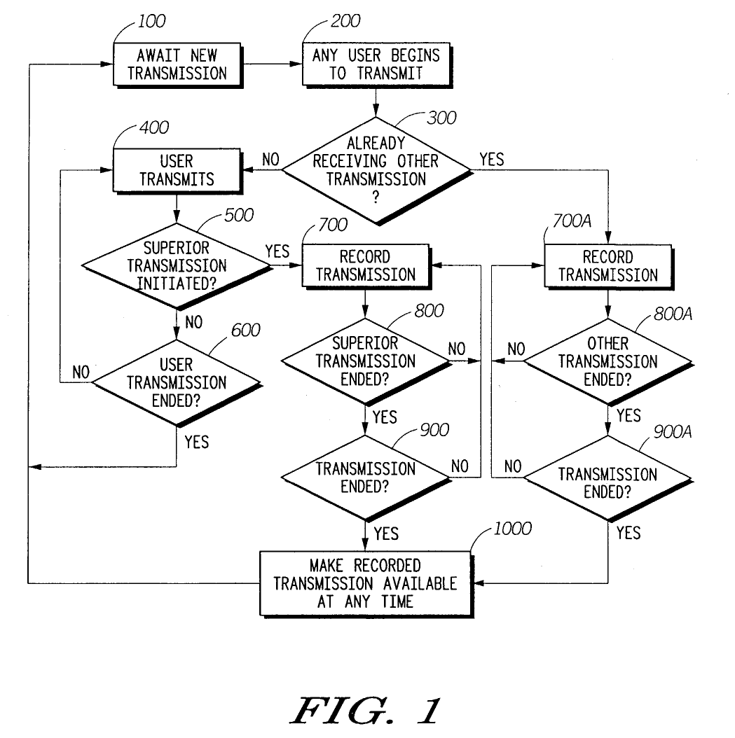

In each embodiment of the method according to the invention, transmission between users and reception by users may be periodic and/or random. Accordingly, each separate communications unit under the method is available to transmit and/or receive at any time. The general method for such communication will be described in conjunction with the flow chart illustrated in FIG. 1.

When neither transmitting nor receiving, a communications unit according to the invention awaits receipt of any transmission from another user or waits the sending of a transmission by the user over any of a number of communications links. See step 100. A communications link can be on a given channel, on multiple channels, through a given communications network, and/or through many different communications networks. Therefore, the link, as it is referred to herein, can take any form of electronic communication and/or be on any kind of electronic communications network. Explanations of some example electronic communications channels and/or networks used by the invention will be given in more detail below.

To begin the communications process, one of the users of the method according to the invention decides to transmit a new message. See step 200. This example of the transmitting user will be referred to below as “the user.” In this context, the message to be transmitted can take any form of electronic communication. For example, the message can be an audio representation of a voice or a digital image, such as a still picture or video stream. The message can also be any kind of code. The communications unit applying the method according to the invention can be programmed to start recording at any time or to record a time stamp at any time. This means that the unit can record upon receipt of any communication, upon start of a new transmission, or any combination thereof. Control of recording according to the invention, therefore, is selective. Selective recording, at it is referred to herein, can include any recording method. It specifically can include performing a determination, upon initiation of a user's wireless transmission, if another wireless transmission is being received already by the user or if the user is transmitting and, if so, recording the user's transmission and/or the other wireless transmission being received for playback by at least one of the user and another user, and, if not, beginning transmission of the user's transmission. Optionally, the recording can also be entirely user-configurable.

Upon the user's initiation of a transmission, a query is conducted in step 300 to determine if the user's transceiver unit is already receiving a transmission from another different user. If the user is receiving no other transmission, then the user's transmission begins to directly transmit the user's message over the communications link. See step 400. If, for example, the user's unit is programmed to record automatically, then the user's communications unit could be already recording the user's message.

It is possible for the user's transmission to be interrupted, for example, by a superior user, such as a dispatcher, who has the ability to suppress any existing transmission between users and, therefore, to transmit over or instead of the currently transmitting user(s). During the time period that the user's communications unit does not detect another transmission (see step 500), the unit continues to transmit the user's transmission until the user's transmission ends. In the context of the invention, an ending of a transmission can be either or both of an actual termination of a transmission or a sufficiently long pause during a transmission. See step 600. Thereafter, the user's unit returns to the transmission-waiting state of step 100.

If, however, the user's communications unit detects a superior user's transmission during the transmission of the user's message, an override process is initiated and begins in step 700. At this point, in one embodiment of the invention, the user's message begins recording so that a recipient can receive and process (decode, hear, view, etc.) the message at a later point in time. In an alternative embodiment of the invention, the method can always be recording the user's message and setting a flag at the point in time when a superior user's transmission is detected, the flag indicating a point of time during the user's transmission at which the superior user's transmission started interrupting the user's transmission. This flag can also be referred to as a time-stamp. Thus, at a later point in time, another user can review the user's entire transmission or a portion thereof, in particular, beginning at the time of the flag.

The override process continues, during recording of the user's transmission, to determine if the superior user's transmission has ended. See step 800. If not, the user's transmission continues to be recorded. When the superior user's transmission ends, there is an inquiry, in step 900, as to whether or not the user's transmission has ended. If the user's transmission has not ended, then recording of the user's transmission continues, unless another superior user's transmission begins prior to conclusion of the user's transmission (a condition not illustrated in FIG. 1). At this point, if no other user is transmitting, then, the user's transmission can be made available, preferably, immediately, to any user, including the user (see step 1000). Such transmission can be recorded at the user's unit and then transmitted, or any other or all of the other users'units can record the user's transmission. Recording by other users'units can be accomplished by either transmitting the user's recorded message in real time simultaneously with the superior user's message or by transmitting the user's recorded message starting after the end of the superior user's transmission, preferably, immediately thereafter. Another alternative allows the user's transmission to be made immediately available in real time at the recipients unit. However, in this alternative case, the middle part of the user's transmission that was overwritten by the superior user's transmission would not have been heard by a recipient and, therefore, if the recipient began hearing the message being transmitted in real time, then the recipient would have missed most or all of the user's message already sent. Accordingly, in a preferred embodiment, the recorded user's message is played back starting at the time of the flag. In other words, the user's message continues after the superior user's message ends as if the superior user never interrupted the user. As such, the recipient (or the user) has lost none of the user's message. In such an embodiment, playback of the user's recorded message can occur even if the user has not finished transmitting by providing a dynamic memory device permitting substantially simultaneous recording and playback. It is noted that the queries in steps 800 and 900 can be reversed or performed simultaneously.

There exists an alternative to the superior user's interruption. Specifically, an interruption by another user (who is not a superior user) can occur during a user's transmission. In such a case, it is not the user's transmission that will be interrupted and recorded (if recording is not automatic). Instead, the other user who is transmitting the interrupting transmission will be recorded and the recording will be made available to the user at a later time, whether immediately after the user stops transmitting or upon the user's manual command. This possibility is not illustrated in FIG. 1, but can simply be sub-steps of the decision of step 500. Specifically, an inquiry would, first, be conducted to determine if any intermediate transmission was initiated after the user's transmission began. If the answer to the inquiry were yes, then another determination would be made to see if the interrupting user is a superior user who would preempt the user's continued transmission. If the interrupting user is a superior user, then the user's transmission will be recorded as set forth above. However, if the interrupting user is not a superior user, then the interrupting user's message would be recorded for playback by the user or another.

As set forth above with respect to the FIG. 1 embodiment, after any user begins to transmit a message (see step 200), the query is conducted to determine if the user's unit is already receiving a transmission from another different user (or, alternatively, the user can already be transmitting). See step 300. In contrast to immediate transmission of the user's message (see step 400), if the user actually is receiving another transmission when the user's transmission begins, then recording of the user's transmission begins immediately. (If recording is only performed at the user's unit, then the transmission can be recorded without being transmitted at all.) This situation initiates a second override process, which begins in step 700A. At this point, the user's message begins recording so that a recipient can process it later. (If recording were performed at each user's unit, then the user's message would be received in real time.) In an alternative embodiment, the method would always be recording the user's message and, at the point in time when the second override process is initiated, an override flag would be set to indicate a point in the other user's transmission at which the user's transmission started. The second override process continues, during recording of the user's transmission, to determine if the other user's transmission has ended. See step 800A. If not, the user's transmission continues to be recorded. When the other user's transmission ends, there is an inquiry, in step 900A, to determine if the user's transmission has ended. If the user's transmission has not ended, then recording of the user's transmission continues; otherwise, recording of the user's transmission ends.

When a transmission is recorded, the transmission can be made available to users for playback (see step 1000) any time after recording begins.

Recording of any users'message can take several forms and can be accomplished in various ways. Additionally, when recording is being made, or thereafter, compression algorithms can be employed to conserve memory or storage area for the recording. Such compression can be real-time compression or post-receipt compression.

Digital or analog recording formats for communications data, such as code, images, audio, and/or video, can include relevant industry standards. Example formats for recording digital audio messages with the unit, for example, include mp3 and wav.

In one embodiment, each user's communications unit can record incoming messages from all monitored sources. As such, a user can later decide which information is played back and when. In an alternative embodiment, the unit can record not only the incoming message, but also the outgoing message. As such, the user can fully replay a conversation in which the user participated. A third alternative can be to record only messages that are not presently the active input. In this context, the “active input” is that message presently being transmitted between the users, i.e., not being recorded in the background. With respect to FIG. 1, the active input can be, for example, the user's transmission when no other transmission is being sent or the superior user's transmission during the time of transmission. A fourth alternative can include ability for the user to switch from one active call to another. In such a case, the unit would continue or start to record that call from which the user just switched. In other words, if a user was speaking to user2 and decided to switch to user3, then the unit would record user2 from the time at which the user switched from user2 to user3. If recording were continuous for all calls, then recording would be flagged at the time at which the user switched from user2 to user3.

These alternatives are not mutually exclusive and can be combined or used selectively in different modes of the unit, the modes being selectable by the user, for example.

The algorithms used and the storage capacity of the unit's memory and/or storage devices can limit recording of a message with the method according to the invention. However, sufficient measures presently exist to effectively record any amount of messages over any amount of time, especially due to the existence of data compression measures. Further, dead air can be compressed or, even, eliminated to more efficiently store recorded messages.

Different configurations can be made to apply the method according to the invention. A first example configuration can be applied to talk-around systems. Such systems have direct communication between units with no intermediate system routing or handling the communication therebetween. A talk-around system can include hand-held walkie-talkies. In such a configuration, each walkie-talkie would have a recording feature/system that records secondary communication when primary communication is being conducted. Simply put, if a first user is presently sending a message, which is received by a second user, and, if the second user tries to send a message while the first user is still talking, then the second user's message will be recorded. The first user will, then, be able to reply the recorded message after the first user's message is complete.

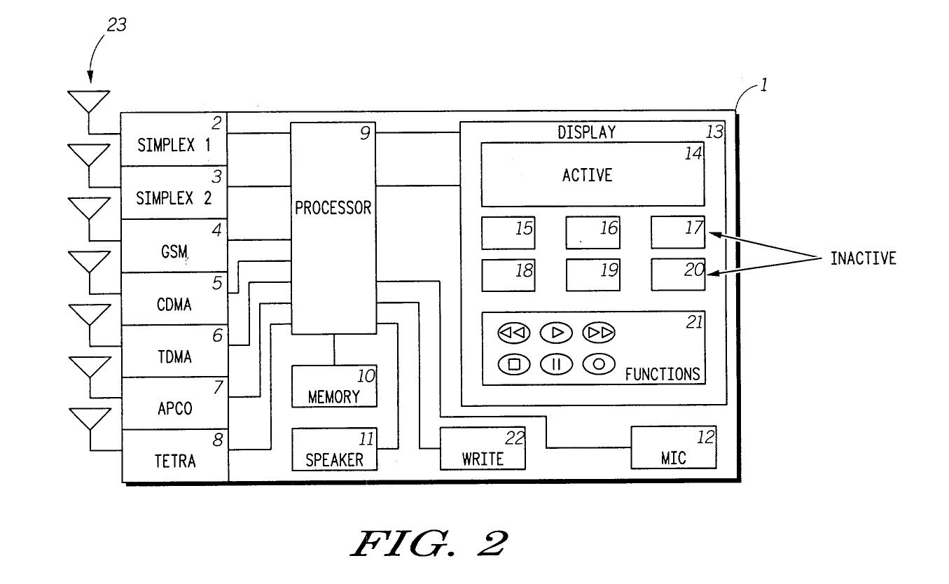

A second example configuration can include multi-receiver systems that apply intermediate message routing systems. These systems include CDMA, Time Division Multiple Access (TDMA), AMPS, GSM, APCO, and TETRA communications, for example. An example device that could apply this configuration is described in association with FIG. 2.

FIG. 2 illustrates one exemplary embodiment of a user communications unit 1 according to the invention. The unit 1 can have various combinations of similar or different transceiver units for communication over separate channels and/or networks. In the example illustrated in FIG. 2, there are seven different transceiver units. The first of the transceiver units is a first simplex communications unit 2, which operates similar to a walkie-talkie. This first simplex unit 2 preferably operates on a given channel, but can be also set to transmit/receive on different channels selected by a user. The second of the transceiver units is a second simplex communications unit 3, which operates similar to the first simplex unit 2, but, preferably, on a channel different from the given channel. Similarly, the second simplex unit 3 also can be set to transmit/receive on any number of different channels selected by a user, including the channels of the first simplex unit 2. For example, the first simplex unit 2 can be set to a dispatch channel, in other words, a channel common to many users, and the second simplex unit 3 can be set to a particular channel of another specific user for direct, two-way communication.

The third, fourth, and fifth of the transceiver units are cell phone-type units operating, respectively, under GSM 4, CDMA 5, and TDMA 6 communications networks.

Finally, the sixth and seventh of the transceiver units are public safety communications units operating, respectively, under the APCO 7 and TETRA 8 communications standards.

The illustrated configuration with the seven transceiver examples is only one possible configuration in a large number of combinations that can include any combination of these transceivers 2 to 8 with any other kind of transceiver unit. Each of the seven example transceiver units 2 to 8 is shown in FIG. 2 with a separate antenna 23. However, the communications unit 1 need not have redundant antennae 23. Any number and/or type of antennae can be combined together and, in a preferred embodiment, only one antenna is used.

Each of the seven example transceiver units 2 to 8 in the example embodiment is connected to a central processing unit 9. This connection can be a group of individual connections, as shown in FIG. 2, or the connection can be through a common non-illustrated bus. The processing unit 9 is connected to a memory 10. The memory 10 can be a single unit, as shown in FIG. 2, or can be individual separate units 10, for example, one for each of the seven transceiver units 2 to 8. Also connected to the processing unit 9 is a speaker or multiple speaker system 11, which can include, additionally, an external speaker connection, and a microphone or multiple microphone system 12, which can include an external microphone connection.

Moreover, a display 13 is connected to the processing unit 9. Preferably, the display 13 is configured to display information according to a given user's preferences. One embodiment of the communications unit 1 can, for example, have a separate display sections for each of the transceiver units 2 to 8. A largest of the sections 14 can be the display for the one active transceiver unit 2 to 8. This display, however, is optional. Information can be conveyed to the user in any way. In this example, “active” can include the one transceiver unit 2 to 8 presently being used by the user for transmission and/or reception. The display sections can include six other inactive sections 15, 16, 17, 18, 19, 20 for displaying information regarding inactive transceiver units 2 to 8. In this example, “inactive” units include those transceiver units 2 to 8 not presently being used by the user for transmission and/or reception. In a preferred embodiment, the display 13 is a touch-screen having various display sections.

The display 13 can also contain a functional display section 21, which contains areas for performing various functions related to stored information regarding the various transceiver units 2 to 8. Functional areas in the functional display section 21 can be similar to functional buttons on a household stereo, videocassette player/recorder, compact disc (CD) player/recorder, and/or a digital video disk (DVD) player/recorder. For example, if audio information is being played with regard to the active display 14, then the following functions would be useful: play, stop, rewind, fast-forward, pause, record, and go to a specified time stamp. Each of these functions is shown in the functional display section 21. Other possible functions can include erase, store/save, or, even, write. The erase function erases the recorded information as selected by the user. The store/save function allows the user to store or save communicated information and to prevent erasure thereof. The write function can indicate that the selected recorded information is written to an external media, for example, a floppy disc, a tape, a CD, a DVD, or any other electronic storage media. The writing device 22 is indicated diagrammatically in FIG. 2.

An example use of the communications unit 1 is set forth in the following text.

A user is a police officer. The officer can communicate with other individuals or entities via cell phone using any of the three cell phone transceivers 4, 5, or 6, for example. Communication with the police dispatcher can take place, for example, over one of the public safety transceivers 7, 8 or by radio through one of the simplex transceiver units 2, 3.

In an example of such communication, it is assumed that the officer is presently talking to another individual by cell phone over the CDMA transceiver 5, during which conversation, information regarding the CDMA transceiver 5 is being displayed in the active display 14. The other transceiver units 2, 3, 4, 6, 7, 8, therefore, are being displayed respectively (possibly in a reduced functional form) in one of the inactive display areas 15 to 20. During the conversation, the police dispatcher begins to transmit one or more messages to the officer over the APCO transceiver 7. At this point in time, two example scenarios exist.

In a first of the scenarios, if the predefined protocol has been defined to force the officer to immediately listen to the dispatcher, then, all communication over the user's CDMA transceiver 5 would be preempted by the user's APCO transceiver 7. (Alternatively, the dispatcher can have an emergency indication within the transmission that forces the officer to listen regardless of the officer's decision to listen at that time.) According to the invention, however, no information still being received over the CDMA transceiver 5 would be lost because at least the officer's unit 1 would immediately start recording all information received by the CDMA transceiver 5 from the point in time when the APCO transceiver 7 took over. (This assumes the officer is not also transmitting via the CDMA transceiver 5. In such a case, the unit 1 would also record the officer's transmission in spite of the fact that the dispatcher's transmission is being played at the officer's unit 1.) At takeover, the CDMA transceiver information would no longer be displayed in the active display 14, but would be moved, for example, to inactive display 15. During the time of such movement, for example, a recording indicator would be displayed in display 15 indicating to the officer that the other individual on the cell call was still on the line (CDMA transceiver 5), but was being placed on hold, and was being recorded until the officer returned to the call or the other individual terminated the call. Simultaneously, information regarding the APCO transceiver 7, previously being displayed, for example, in display 18, would be switched to the active display 14 and show any relevant dispatcher information or APCO transceiver information to the officer. For example, if a digital picture was being sent to the officer concurrent with the dispatcher call, such a picture could be displayed in the active display 14.

In an alternative scenario, if the predefined protocol has been defined not to force the officer to immediately listen to the dispatcher or to give the officer the choice of immediately answering the dispatcher call, then the officer has the ability to continue with the cell phone call and have the unit 1 begin recording any information from the dispatcher, whether automatically or by manual activation of a functional indicator on the display 13 or elsewhere. Appropriate functional displays can be shown in real time to the officer to enable the officer to make such decisions while still on the cell phone call. If the officer indicates that the dispatcher's information should be recorded for later review (preferably, the recording is being performed already), then the officer can continue the cell phone call and, when finished, activate the appropriate functional displays to replay the message from the dispatcher.

These examples are only two possible scenarios in a variety of many different scenarios possible with the transceiver units 2 to 8 and the display configuration 13 to 21. In each possible example, the unit 1 according to the invention provides the user with the ability to record any number of simultaneous transmissions to the user without loss of information from any of the potential sources.

I claim:

1. A method for recording data on multiple wireless communications channels, which comprises:
selectively recording the user's transmission for playback by at least one of the user and another user; and
if another new wireless transmission starts to be received by the user during the user's transmission, performing one of the following steps:
continuing transmission of the user's transmission and recording the new wireless transmission at least from a beginning of the new wireless transmission for playback by at least one of the user and another user; and
stopping transmission of the user's transmission and at least starting to record at least a remainder of the user's transmission at least from the beginning of the new wireless transmission for playback by at least one of the user and another user, and receiving the new wireless transmission by the user.

2. The method according to claim 1, which further comprises carrying out the selective recording by determining, upon initiation of a user's wireless transmission, if another wireless transmission is being received already by the user and:
if so, recording the user's transmission for playback by at least one of the user and another user; and
if not, beginning transmission of the user's transmission.

3. The method according to claim 2, which further comprises determining, upon initiation of a user's wireless transmission on a given communications link, if another wireless transmission is being received already by the user on the same communications link.

4. The method according to claim 3, wherein the communications link is a link selected from a group consisting of a communications channel and a communications network.

5. The method according to claim 2, which further comprises determining, upon initiation of a user's wireless transmission on a given communications link, if another wireless transmission is being received already by the user on a different communications link.

6. The method according to claim 5, wherein the communications link is a link selected from a group consisting of a communications channel and a communications network.

7. The method according to claim 1, which further comprises carrying out the continuing transmission step by continuing transmission of the user's transmission and simultaneously recording the new wireless transmission at least from a beginning of the new wireless transmission for playback by at least one of the user and another user.

8. The method according to claim 7, which further comprises carrying out the stopping, starting, and receiving steps by immediately stopping transmission of the user's transmission and immediately starting to record at least a remainder of the user's transmission at least from the beginning of the new wireless transmission for playback by at least one of the user and another user, and simultaneously immediately receiving the new wireless transmission by the user.

9. The method according to claim 1, which further comprises carrying out at least one of the recording steps by digitally storing the recorded transmission in a memory.

10. The method according to claim 9, which comprises storing the recorded transmission in a format selected from a group consisting of mp3, wav, wma, real audio, quicktime, avi, mpeg, bmp, jpeg, gif, divx, and raw digital data.

11. The data recorder according to claim 9, which further comprises carrying out the digitally storing step by writing the digitally recorded transmission on an external writing media.

12. The method according to claim 1, which further comprises carrying out at least one of the recording steps by storing the recorded transmission in a memory located at a place of origin of the transmission.

13. The method according to claim 1, which comprises which further comprises carrying out at least one of the recording steps by storing the recorded transmission in a memory located at a place of reception of the transmission.

14. The method according to claim 1, which further comprises carrying out at least one of the recording steps by storing the recorded transmission in a memory located both at a place of origin of the transmission and at a place of reception of the transmission.

15. The method according to claim 1, wherein at least one of the user's transmission and the new wireless transmission includes digital data selected from a group consisting of a digital code, a digital audio signal, a digital image, and a digital video stream.

16. The method according to claim 1, which further comprises playing back at least one of the recorded transmissions after the new wireless transmission has ended.

17. The method according to claim 1, which further comprises playing back at least one of the recorded transmissions after the user's transmission has ended.

18. The method according to claim 1, which further comprises playing back at least one of the recorded transmissions one of:
beginning from a starting point of a recorded transmission; and
beginning from a user-selected point of time within a recorded transmission.

19. The method according to claim 1, which comprises carrying out at least the recording of the user's transmission with a processor for at least one of later transmission and playback by at least one of the user and another user.

20. The method according to claim 1, which comprises carrying out the stopping of the user's transmission and the starting of the recording of at least the remainder of the user's transmission with a processor at least from the beginning of the new wireless transmission for at least one of later transmission and playback by at least one of the user and another user.

21. The method according to claim 1, which further comprises carrying out at least one of the recording steps by substantially eliminating dead air within the recorded transmissions.

22. The method according to claim 1, which further comprises carrying out at least one of the recording steps by compressing at least one of the recorded transmissions and dead air within the recorded transmissions.

23. A method for recording data on multiple wireless communications channels, which comprises:
determining, upon initiation of a user's wireless transmission, if another wireless transmission is being received already by the user and:
if so, recording the user's transmission for playback by at least one of the user and another user; and
if not, beginning transmission of the user's transmission; and
if another new wireless transmission starts to be received by the user during the user's transmission, performing one of the following steps:
continuing transmission of the user's transmission and recording the new wireless transmission at least from a beginning of the new wireless transmission for playback by at least one of the user and another user; and
stopping transmission of the user's transmission and starting to record at least a remainder of the user's transmission at least from the beginning of the new wireless transmission for playback by at least one of the user and another user, and receiving the new wireless transmission by the user.

24. A method for recording data including at least one of a digital code, a digital audio signal, a digital image, and a digital video stream on multiple wireless communications channels, which comprises:
determining, upon initiation of a user's wireless transmission, if another wireless transmission is being received already by the user and:
if so, digitally recording the user's transmission in at least one memory for playback by at least one of the user and another user; and
if not, beginning transmission of the user's transmission; and
if another new wireless transmission starts to be received by the user during the user's transmission, performing one of the following steps:
continuing transmission of the user's transmission and simultaneously digitally recording the new wireless transmission at least from a beginning of the new wireless transmission in the at least one memory for playback by at least one of the user and another user; and
immediately stopping transmission of the user's transmission and immediately starting to digitally record at least a remainder of the user's transmission at least from the beginning of the new wireless transmission in the at least one memory for playback by at least one of the user and another user, and simultaneously immediately receiving the new wireless transmission by the user; and
playing back at least one of the recorded transmissions after at least one of:
the new wireless transmission has ended; and
the user's transmission has ended.

25. A multiple channel data recorder, comprising:
at least one wireless communications transceiver;
a display; and
a processor connected to said at least one transceiver and to said display, said processor being programmed to selectively record the user's transmission for playback by at least one of the user and another user; and
if another new wireless transmission starts to be received by the user during the user's transmission, said processor being programmed to perform one of the following steps:
continue transmitting the user's transmission and record the new wireless transmission at least from a beginning of the new wireless transmission for playback by at least one of the user and another user; and
stop transmitting the user's transmission and start recording at least a remainder of the user's transmission at least from the beginning of the new wireless transmission for playback by at least one of the user and another user, and receive the new wireless transmission by the user.

26. The data recorder according to claim 25, wherein said processor is programmed to carry out the selective recording by determining, upon initiation of a user's wireless transmission, if another wireless transmission is being received already by the user and:
if so, to record the user's transmission for playback by at least one of the user and another user; and
if not, to begin transmitting the user's transmission through said at least one transceiver.

27. The data recorder according to claim 25, wherein said processor is programmed to carry out the recording of a transmission with said processor for at least one of later transmission and playback by at least one of the user and another user.

28. The data recorder according to claim 25, wherein said processor is programmed to carry out the stopping of the user's transmission and the starting of the recording at least a remainder of the user's transmission with said processor at least from the beginning of the new wireless transmission for at least one of later transmission and playback by at least one of the user and another user.

29. The data recorder according to claim 25, wherein said at least one transceiver is a plurality of transceivers.

30. The data recorder according to claim 29, wherein said transceivers include at least one of a simplex transceiver, a CDMA transceiver, a TDMA transceiver, an AMPS transceiver, a GSM transceiver, an APCO transceiver, and a TETRA transceiver.

31. The data recorder according to claim 29, wherein said transceivers have one of a single common antenna, a plurality of antennae, and separate antennae.

32. The data recorder according to claim 25, including a bus connecting said at least one transceiver to said processor.

33. The data recorder according to claim 25, including at least one memory connected to said processor for storing recorded transmission data.

34. The data recorder according to claim 33, wherein said processor is programmed to play back recorded transmission data stored in said at least one memory.

35. The data recorder according to claim 33, including a writing device connected to said processor for writing data on an external writing media, said processor being programmed to write recorded transmission data stored in said at least one memory on the external writing media.

36. The data recorder according to claim 25, including at least one speaker and at least one microphone each respectively connected to said processor.

37. The data recorder according to claim 25, wherein said display has user-configurable display sections.

38. The data recorder according to claim 29, wherein:
said display has user-configurable display sections; and
at least one of said display sections is associated with each of said transceivers.

39. The data recorder according to claim 25, wherein said display is a touch-screen.

40. A multiple channel data recorder, comprising:
at least one wireless communications transceiver;
a display; and
a processor connected to said at least one transceiver and to said display, said processor being programmed to determine, upon initiation of a user's wireless transmission, if another wireless transmission is being received already by the user and:
if so, to record the user's transmission for playback by at least one of the user and another user; and
if not, to begin transmitting the user's transmission through said at least one transceiver; and
if another new wireless transmission starts to be received by the user during the user's transmission, said processor being programmed to perform one of the following steps:
continue transmitting the user's transmission and record the new wireless transmission at least from a beginning of the new wireless transmission for playback by at least one of the user and another user; and
stop transmitting the user's transmission and start recording at least a remainder of the user's transmission at least from the beginning of the new wireless transmission for playback by at least one of the user and another user, and receive the new wireless transmission by the user.

41. A multiple channel data recorder, comprising:
a plurality of wireless communications transceivers including at least one of a simplex transceiver, a CDMA transceiver, a TDMA transceiver, an AMPS transceiver, a GSM transceiver, an APCO transceiver, and a TETRA transceiver;
a display having user-configurable display sections;
a speaker;
a microphone;
a processor connected to said transceivers, to said display, to said speaker, and to said microphone;
at least one memory connected to said processor for storing recorded communications data;
said processor being programmed:
to determine, upon initiation of a user's wireless transmission, if another wireless transmission is being received already by the user and:
if so, to record the user's transmission at least in said memory for playback by at least one of the user and another user; and
if not, to begin transmitting the user's transmission through said at least one transceiver; and
if another new wireless transmission starts to be received by the user during the user's transmission, said processor being programmed:
to continue transmitting the user's transmission and to record the new wireless transmission at least in said memory at least from a beginning of the new wireless transmission for playback by at least one of the user and another user; and
to stop transmitting the user's transmission and to start recording at least a remainder of the user's transmission at least in said memory at least from the beginning of the new wireless transmission for playback by at least one of the user and another user, and to receive the new wireless transmission by the user; and
to play back recorded communications data stored in said memory on at least one of said display sections, said speaker, and said microphone.

42. A multiple channel data recording system, comprising:
at least two multiple channel data recorders each having:
at least one wireless communications transceiver;
a display; and
a processor connected to said at least one transceiver and to said display, said processor being programmed to selectively record the user's transmission for playback by at least one of the user and another user; and
if another new wireless transmission starts to be received by the first user from the second user during the first user's transmission, said processor being programmed:
to continue transmitting the first user's transmission and to record the second user's transmission at least from a beginning of the second user's transmission for playback by at least one of the first user and the second user; and
to stop transmitting the first user's transmission and to start recording at least a remainder of the first user's transmission at least from the beginning of the second user's transmission for playback by at least one of the first user and the second user, and to receive the second user's transmission by the first user.
